(19) United States
(12) Patent Application Publication
(10) Pub. No.: US 2023/0182115 A1
(43) Pub. Date: Jun. 15, 2023

(54) SORBENT POLYMER COMPOSITES INCLUDING PHOSPHONIUM HALIDES, FLUE GAS TREATMENT DEVICES AND FLUE GAS TREATMENT METHODS UTILIZING THE SAME

(71) Applicant: W. L. Gore & Associates, Inc., Newark, DE (US)

(72) Inventor: Steven Hardwick, Newark, DE (US)

(21) Appl. No.: 17/925,162

(22) PCT Filed: May 10, 2021
(86) PCT No.: PCT/US2021/031652

§ 371 Date: Nov. 14, 2022

Related U.S. Application Data
(60) Provisional application No. 63/023,427, filed on May 12, 2020.

(51) Int. Cl. B01J 20/32; B01D 53/50; B01D 53/64; B01J 20/26

(52) U.S. Cl. CPC B01J 20/3204; B01D 53/508; B01D 53/64; B01J 20/26; B01D 2257/302; B01D 2257/602; B01D 2258/0283; B01D 2253/25; B01D 2253/202; B01D 2253/102; B01J 20/28064

(57) ABSTRACT

Some embodiments of the present disclosure relate to a device comprising a sorbent polymer composite and at least one phosphonium halide. In some embodiments, the device is configured to treat a flue gas stream. In some embodiments, the flue gas stream comprises oxygen, water vapor, at least one SOx compound, and mercury vapor. Some embodiments of the present disclosure relate to a method comprising treating the flue gas stream by: passing the flue gas stream over the device, reacting the oxygen and water vapor of the flue gas stream with the at least one SOx compound on the sorbent polymer composite, so as to form sulfuric acid, and reacting the mercury vapor with the at least one phosphonium halide, so as to fix molecules of the mercuiy vapor to the sorbent polymer composite.

### CROSS-REFERENCE TO RELATED APPLICATION

This application is a national phase application of PCT Application No. PCT/US2021/031652, internationally filed on May 10, 2021, which claims the benefit of U.S. Provisional Application No. 63/023,427, filed May 12, 2020, which are herein incorporated by reference in their entireties for all purposes.

### FIELD

Some embodiments of the present disclosure relate to sorbent polymer composites that include phosphonium halides. The sorbent polymer composites of such embodiments may be utilized in devices and methods as described herein.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO₂), mercury (Hg) vapor, and particulate matter (PM). In the United States, burning coal alone generates about 27 million tons of SO₂ and 45 tons of Hg each year.

There is an ongoing need to provide systems that can remove multiple flue gas pollutants such as, but not limited to, Sax, Hg vapor, and particulate matter at low cost.

### SUMMARY

The subject matter should be understood by reference to appropriate portions of the entire specification, any or all drawings, and each claim.

Some aspects of the present disclosure relate to a device comprising a sorbent polymer composite, wherein the sorbent polymer composite comprises: a sorbent, a polymer, and at least one phosphonium halide. In some such aspects, the phosphonium halide has a very high thermal stability. Accordingly, in such aspects, the phosphonium halide can be relevant for high temperature application(s). In some such aspects, the at least one phosphonium halide may be disposed on the sorbent polymer composite, disposed within the sorbent polymer composite, or any combination thereof. In some aspects, the at least one phosphonium halide may be disposed within the sorbent polymer composite. In some aspects, the device may also be configured to treat a flue gas stream.

In some aspects, the at least one phosphonium halide comprises a compound with a formula: P(R₁R₂R₃R₄)X, wherein X=I⁻, Br⁻, I₃⁻, BrI₂I₂⁻, or Br₃⁻, and wherein at least one of R₁, R₂, R₃ or R₄ is a hydrocarbon having from 1 to 18 carbon atoms. In some aspects, the hydrocarbon is chosen from an alkyl, an aryl, or a cyclic alkyl. In some aspects, the at least one phosphonium halide comprises a quaternary phosphonium iodide. In some aspects, the at least one phosphonium halide comprises a quaternary phosphonium bromide. In some aspects, the at least one phosphonium halide comprises a quaternary phosphonium triiodide. In some aspects, the at least one phosphonium halide comprises a quaternary phosphonium tribromide. In some aspects, the at least one phosphonium halide comprises ethyltriphenylphosphonium iodide (ETPPI). In some aspects, the at least one phosphonium halide comprises tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), or any combination thereof.

In some aspects, the at least one phosphonium halide is thermally stable, such that the at least one phosphonium halide retains a single molecular formula, at temperatures in excess of 180° C. In some aspects, the at least one phosphonium halide is thermally stable, such that the at least one phosphonium halide retains a single molecular formula, at temperatures from 180° C. to 400° C. In some aspects, the at least one phosphonium halide is thermally stable, such that the at least one phosphonium halide retains a single molecular formula, at temperatures from 200° C. to 400° C. In some aspects, the sorbent of the sorbent polymer composite has a surface area in excess of 400 m²/g. In some aspects, the sorbent of the sorbent polymer composite has a surface area ranging from 400 m²/g to 2000 m²/g. In some aspects, the sorbent of the sorbent polymer composite is chosen from: activated carbon, silica gel, zeolites, or any combination thereof. In some aspects, the polymer of the sorbent polymer composite has a surface energy of less than 31 dynes per cm. In some aspects, the polymer of the sorbent polymer composite has a surface energy ranging from 15 dynes per cm to 31 dynes per cm. In some aspects, the polymer of the sorbent polymer composite comprises a fluoropolymer. In some aspects, the fluoropolymer is expanded polytetrafluoroethylene (ePTFE). In some aspects, the at least one phosphonium halide is disposed within the sorbent polymer composite.

Some aspects of the present disclosure relate to a method of treating a flue gas stream. In some such aspects, the flue gas stream may comprise oxygen, water vapor, at least one Sax compound, and mercury vapor. In some such aspects, the method may comprise passing the flue gas stream over a device, where the device comprises a sorbent polymer composite, and where the sorbent polymer composite comprises a sorbent, a polymer, and at least one phosphonium halide. In some aspects, the at least one phosphonium halide is disposed on the sorbent polymer composite, disposed within the sorbent polymer composite, or any combination thereof. In some aspects, the method may further comprise reacting the oxygen and water vapor with the at least one Sax compound on the sorbent polymer composite, so as to form sulfuric acid. In some aspects, the method may further comprise reacting the mercury vapor with the at least one phosphonium halide, so as to fix molecules of the mercury vapor to the sorbent polymer composite. In some aspects, the method further comprises, prior to the treating step, obtaining the flue gas stream from at least one combustion process. In some aspects, the at least one SOₓ compound comprises sulfur dioxide (SO₂), sulfur trioxide (SO₃), or any combination thereof.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is an illustration of a device, in the form of a flue gas treatment unit, according to some embodiments of the present disclosure.

FIGS. 2A and 2B are simplified illustrations of sorbent polymer composites in accordance with some embodiments of the present disclosure.

FIG. 3 is a chart showing Langmuir Adsorption isotherms of various exemplary phosphonium halides in accordance with some embodiments of the present disclosure.

FIG. 4 is a chart showing the stability of ethyltriphenylphosphonium iodide (ETPPI) as a function of temperature in a thermal gravimetric analysis in accordance with some embodiments of the present disclosure.

FIG. 5 is a chart showing the stability of tetrabuylphosphonium iodide as a function of temperature in a thermal gravimetric analysis in accordance with some embodiments of the present disclosure.

FIG. 6 is a chart showing the stability of ethyltriphenylphosphonium bromide (ETPPBr) as a function of temperature in a thermal gravimetric analysis in accordance with some embodiments of the present disclosure.

FIG. 7 is a chart showing the stability of tetrabuylphosphonium bromide (TBPBr) as a function of temperature in a thermal gravimetric analysis in accordance with some embodiments of the present disclosure.

FIG. 8 is a second chart showing the stability of ethyltriphenylphosphonium tri-iodide (ETPPI₃) as a function of temperature in a thermal gravimetric analysis in accordance with some embodiments of the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising” “including,” and “having” do not limit the scope of a specific claim to the materials or steps recited by the claim.

As used herein, the term “consisting essentially of” limits the scope of a specific claim to the specified materials or steps and those that do not materially affect the basic and novel characteristic or characteristics of the specific claim.

As used herein, terms such as “consisting of” and “composed of” limit the scope of a specific claim to the materials and steps recited by the claim.

All prior patents, publications, and test methods referenced herein are incorporated by reference in their entireties.

As used herein, the term “sorbent” means a substance which has the property of collecting molecules of another substance by at least one of absorption, adsorption, or combinations thereof.

As used herein, the term “composite” refers to a material including two or more constituent materials with different physical or chemical properties that, when combined, result in a material with characteristics different from the individual components.

As used herein, a “sorbent polymer composite” is a composite that includes a sorbent and a polymer. In embodiments the sorbent polymer composite may comprise sorbent particles that are incorporated into a microstructure of a polymer.

As used herein “thermally stable” means that a compound retains a single molecular formula over a specified temperature range.

As used herein, a “flue gas” refers to a gaseous mixture that comprises at least one byproduct of a combustion process (such as, but not limited to, a coal combustion process). In some embodiments, a flue gas may consist entirely of byproducts of a combustion process. In some embodiments, a flue gas may include at least one gas in an elevated concentration relative to a concentration resulting from the combustion process. For instance, in one non-limiting example, a flue gas may be subjected to a “scrubbing” process during which water vapor may be added to the flue gas. Accordingly, in some such embodiments, the flue gas may include water vapor in an elevated concentration relative to the initial water vapor concentration due to combustion. Similarly, in some embodiments, a flue gas may include at least one gas in a lesser concentration relative to an initial concentration of the at least one gas output from the combustion process. This may occur, for example, by removing at least a portion at least one gas after combustion. In some embodiments, a flue gas may take the form of a gaseous mixture that is a combination of byproducts of multiple combustion processes.

As used herein, a “SOₓ compound” refers to refers to any oxide of sulfur. In some non-limiting embodiments, “SOₓ compound” may specifically refer to gaseous oxides of sulfur that are known environmental pollutants. Non-limiting examples of SOₓ compounds include sulfur dioxide (SO₂) and sulfur trioxide (SO₃). Additional non-limiting examples of SOₓ compounds include sulfur monoxide (SO), disulfur monoxide (S₂O), and disulfur dioxide (S₂O₂).

As used herein, “mercury vapor” refers to a gaseous compound comprising mercury. Non-limiting examples of mercury vapor include elemental mercury vapor and oxidized mercury vapor.

As used herein, “oxidized mercury vapor” is defined as a vapor-phase mercury compound that includes mercury in a positive valence state. Non-limiting examples of oxidized mercury vapor include mercurous halides and mercuric halides.

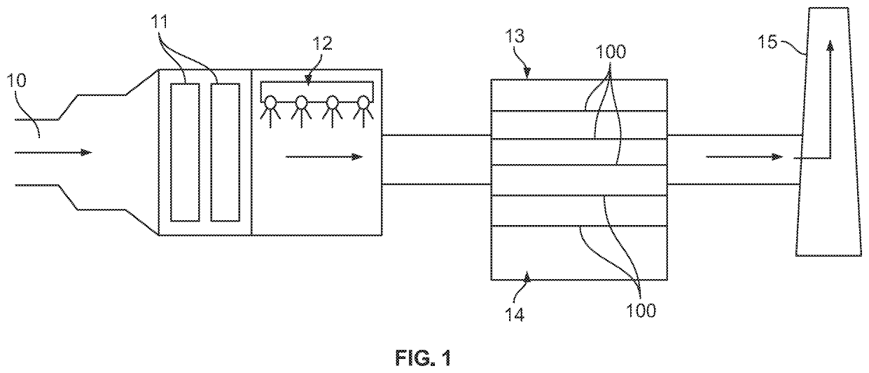

Some embodiments of the present disclosure relate to a device. FIG. 1 shows a schematic of an exemplary device according to some non-limiting embodiments of the present disclosure. As shown, flue gas 10 stream from a combustor may be reduced in temperature by heat exchangers and introduced in an electrostatic precipitator or bag house 11. In some embodiments, the treated flue gas stream can be further reduced in temperature by a treatment unit 12. In some embodiments, the treatment unit 12 includes a water spray which will additionally increase gas humidity. In some embodiments, treatment unit 12 may include a limestone scrubber for the removal of SO₂. In some embodiments, the treated flue gas is introduced into a sorbent housing 13 that includes a sorbent polymer composite 100 according to some embodiments of the present disclosure. In some embodiments, (not shown), the sorbent house may conveniently be located at the top of a limestone scrubber. In some embodiments of the exemplary device shown in FIG. 1, at least one SOₓ compound is converted to sulfuric acid on a surface of the sorbent polymer composite 100. In some embodiments, mercury vapor in the treated flue gas 10 is absorbed onto the sorbent polymer composite 100. In some embodiments, expelled sulfuric acid may drip down to an acid reservoir 14. In some embodiments, treated flue gas exits the sorbent housing 13 and exits a stack 15.

In some embodiments, the device described herein is configured to treat a flue gas stream. In some embodiments, the flue gas stream comprises at least one of: oxygen, water vapor, at least one SOₓ compound, mercury vapor, or any combination thereof. In some embodiments, the flue gas stream comprises oxygen, water vapor, and at least one SOₓ compound. In some embodiments, the flue gas stream comprises oxygen, water vapor, and a plurality of SOₓ compounds. In some embodiments, the flue gas stream comprises oxygen, water vapor, and mercury vapor. In some embodiments, the flue gas stream comprises oxygen, water vapor, at least one SOₓ compound, and mercury vapor. In some embodiments, the flue gas stream comprises oxygen, water vapor, a plurality of SOₓ compounds, and mercury vapor. In some embodiments, the oxygen may be present in air, such that the flue gas stream comprises nitrogen.

In some embodiments, the at least one SOₓ compound or plurality of SOₓ compounds in the flue gas stream is chosen from sulfur dioxide (SO₂), sulfur trioxide (SO₃), sulfur monoxide (SO), disulfur monoxide (S₂O), disulfur dioxide (S₂O₂), or any combination thereof. In some embodiments, the at least one SOₓ compound or plurality of SOₓ compounds in the flue gas stream is selected from the group consisting of sulfur dioxide (SO₂), sulfur trioxide (SO₃), sulfur monoxide (SO), disulfur monoxide (S₂O), disulfur dioxide (S₂O₂), and any combination thereof.

In some embodiments, the at least one SOₓ compound or plurality of SOₓ compounds in the flue gas stream is chosen from sulfur dioxide (SO₂), sulfur trioxide (SO₃), or any combination thereof. In some embodiments, the at least one SOₓ compound or plurality of SOₓ compounds in the flue gas stream is selected from the group consisting of sulfur dioxide (SO₂), sulfur trioxide (SO₃), and any combination thereof.

In some embodiments, the mercury vapor is chosen from elemental mercury vapor, oxidized mercury vapor, or any combination thereof. In some embodiments, the mercury vapor is selected from the group consisting of elemental mercury vapor, oxidized mercury vapor, and any combination thereof.

In some embodiments, the oxidized mercury vapor comprises one or more mercury halides. In some embodiments, the mercury halide is a mercuric halide. In some embodiments, the mercuric halide includes one or more of a mercury (II) chloride, a mercury (II) bromide or a mercury (II) iodide. In some embodiments, the mercury halide is a mercurous halide. In some embodiments, the mercurous halide includes one or more of a mercury (I) chloride, mercury (I) bromide or mercury (I) iodide.

In some embodiments, the device comprises a sorbent polymer composite (SPC). In some embodiments, the sorbent polymer composite comprises a sorbent and a polymer.

A sorbent polymer composite (SPC), such as but not limited to, a SPC comprising activated carbon filled polytetrafluoroethylene (PTFE), has been proven to be particularly effective in removing undesirable components from a flue gas stream. Such undesirable components, may include, but are not limited to, at least one SOx compound and mercury vapor. In some embodiments, the sorbent polymer composite (SPC) can include one or more homopolymers, copolymers or terpolymers containing at least one fluoromonomer with or without additional non-fluorinated monomers.

In some embodiments, the polymer of the sorbent polymer composite includes at least one of: polyfluoroethylene propylene (PFEP); polyperfluoroacrylate (PPFA); polyvinylidenefluoride (PVDF); a terpolyrner of tetrafluoroethylene, hexafluoropropylene-vinylidene-fluoride (THV), polychlorotrifluoroethylene (PCFE), poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or combinations thereof. In some embodiments, the polymer is polytetrafluoroethylene (PTFE). In some embodiments, the polymer is expanded polytetrafluoroethylene (ePTFE). In some embodiments, the structure of the polymer can become porous upon stretching, such that voids can form between fibrils and nodes of the polymer.

In some embodiments, the polymer material of the sorbent polymer composite (SPC) can include polyvinylidene fluoride (PVDF). In some embodiments, the PVDF may be a PVDF homopolymer. In some embodiments the PVDF may be a PVDF copolymer. In some embodiments, the PVDF copolymer is a copolymer of PVDF and hexafluoropropylene (HFP). Non-limiting commercial examples of PVDF homopolymers or copolymers that may be suitable for some embodiments of the present disclosure, include but are not limited to Kynar Flex® and Kynar Superflex®, each of which is commercially available from the company Arkema.

In some embodiments, the polymer of the sorbent polymer composite has a surface energy of less than 31 dynes per cm. In some embodiments, the polymer of the sorbent polymer composite has a surface energy of less than 30 dynes per cm. In some embodiments, the polymer of the sorbent polymer composite has a surface energy of less than 25 dynes per cm. In some embodiments, the polymer of the sorbent polymer composite has a surface energy of less than 20 dynes per cm. In some embodiments, the polymer of the sorbent polymer composite has a surface energy of less than 15 dynes per cm.

In some embodiments, the polymer of the sorbent polymer composite has a surface energy ranging from 15 dynes per cm to 31 dynes per cm. In some embodiments, the polymer of the sorbent polymer composite has a surface energy ranging from 20 dynes per cm to 31 dynes per cm. In some embodiments, the polymer of the sorbent polymer composite has a surface energy ranging from 25 dynes per cm to 31 dynes per cm. In some embodiments, the polymer of the sorbent polymer composite has a surface energy ranging from 30 dynes per cm to 31 dynes per cm.

In some embodiments, the polymer of the sorbent polymer composite has a surface energy ranging from 15 dynes per cm to 30 dynes per cm. In some embodiments, the polymer of the sorbent polymer composite has a surface energy ranging from 15 dynes per cm to 25 dynes per cm. In some embodiments, the polymer of the sorbent polymer composite has a surface energy ranging from 15 dynes per cm to 20 dynes per cm.

In some embodiments, the polymer of the sorbent polymer composite has a surface energy ranging from 20 dynes per cm to 25 dynes per cm.

In some embodiments, the sorbent of the sorbent polymer composite comprises activated carbon, silica gel, zeolite, or combinations thereof. In some embodiments, the sorbent of the sorbent polymer composite (SPC) comprises activated carbon. In some embodiments, the activated carbon is coal-derived carbon, lignite-derived carbon, wood-derived carbon, coconut-derived carbon or any combination thereof. In some embodiments, when the sorbent is combined with the polymer, the resulting mixture can be stretched to form a porous structure without displacing the sorbent.

In some embodiments, the sorbent of the sorbent polymer composite has a surface area in excess of 400 m²/g. In some embodiments, the sorbent of the sorbent polymer composite has a surface area in excess of 600 m²/g. In some embodiments, the sorbent of the sorbent polymer composite has a surface area in excess of 800 m²/g. In some embodiments, the sorbent of the sorbent polymer composite has a surface area in excess of 1000 m²/g. In some embodiments, the sorbent of the sorbent polymer composite has a surface area in excess of 1200 m²/g. In some embodiments, the sorbent of the sorbent polymer composite has a surface area in excess of 1400 m²/g. In some embodiments, the sorbent of the sorbent polymer composite has a surface area in excess of 1600 m²/g. In some embodiments, the sorbent of the sorbent polymer composite has a surface area in excess of 1800 m²/g. In some embodiments, the sorbent of the sorbent polymer composite has a surface area in excess of 2000 m²/g.

In some embodiments, the sorbent of the sorbent polymer composite has a surface area ranging from 400 m²/g to 2000 m²/g. In some embodiments, the sorbent of the sorbent polymer composite has a surface area ranging from 600 m²/g to 2000 m²/g. In some embodiments, the sorbent of the sorbent polymer composite has a surface area ranging from 800 m²/g to 2000 m²/g. In some embodiments, the sorbent of the sorbent polymer composite has a surface area ranging from 1000 m²/g to 2000 m²/g. In some embodiments, the sorbent of the sorbent polymer composite has a surface area ranging from 1200 m²/g to 2000 m²/g. In some embodiments, the sorbent of the sorbent polymer composite has a surface area ranging from 1400 m²/g to 2000 m²/g. In some embodiments, the sorbent of the sorbent polymer composite has a surface area ranging from 1600 m²/g to 2000 m²/g. In some embodiments, the sorbent of the sorbent polymer composite has a surface area ranging from 1800 m²/g to 2000 m²/g.

In some embodiments, the sorbent of the sorbent polymer composite has a surface area ranging from 400 m²/g to 1800 m²/g. In some embodiments, the sorbent of the sorbent polymer composite has a surface area ranging from 400 m²/g to 1600 m²/g. In some embodiments, the sorbent of the sorbent polymer composite has a surface area ranging from 400 m²/g to 1400 m²/g. In some embodiments, the sorbent of the sorbent polymer composite has a surface area ranging from 400 m²/g to 1200 m²/g. In some embodiments, the sorbent of the sorbent polymer composite has a surface area ranging from 400 m²/g to 1000 m²/g. In some embodiments, the sorbent of the sorbent polymer composite has a surface area ranging from 400 m²/g to 800 m²/g. In some embodiments, the sorbent of the sorbent polymer composite has a surface area ranging from 400 m²/g to 600 m²/g.

In some embodiments, the sorbent of the sorbent polymer composite has a surface area ranging from 600 m²/g to 1800 m²/g. In some embodiments, the sorbent of the sorbent polymer composite has a surface area ranging from 800 m²/g to 1600 m²/g. In some embodiments, the sorbent of the sorbent polymer composite has a surface area ranging from 1000 m²/g to 1400 m²/g.

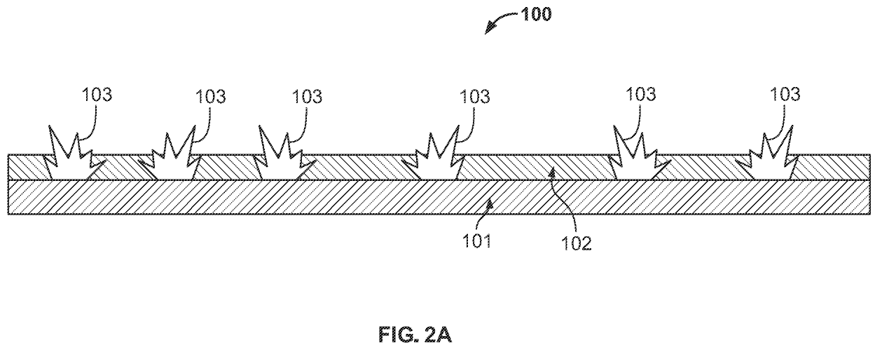

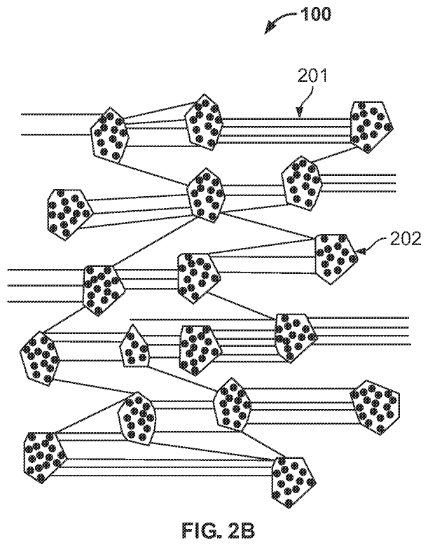

FIG. 2A depicts a non-limiting embodiment of a sorbent polymer composite 100 described herein, in a cross-sectional view. In this non-limiting embodiment, the sorbent polymer composite 100 includes a sorbent 102 that partially or completely covers a polymer 101. In some non-limiting embodiments, at least one phosphonium halide 103 (as described herein) can partially or completely cover portions of the sorbent 102. In some embodiments, the at least one phosphonium halide 103 may be imbibed into pores of the sorbent 102.

FIG. 2B depicts an additional a non-limiting embodiment of a sorbent polymer composite 100 described herein. As shown, sorbent polymer composite 100 may comprise sorbent 102 particles that are incorporated into a microstructure 201 of a polymer. In some embodiments, the sorbent 102 particles may be activated carbon particles. In some embodiments, the microstructure 201 of the polymer may comprise fibrils. In some embodiments, the polymer may be expanded PTFE.

Additional non-limiting configurations of the sorbent polymer composite described herein are set out in U.S. Pat. No. 9,827,551 to Hardwick et al and U.S. Pat. No. 7,442,352 to Lu et al, each of which are incorporated by reference herein in their entireties.

In some embodiments, the sorbent polymer composite (SPC) may be formed by blending polymer particles with sorbent particles in a manner such as generally taught in U.S. Pat. No. 7,710,877, US Publication No. 2010/0119699, U.S. Pat. Nos. 5,849,235, 6,218,000 or 4,985,296, each of which is incorporated by reference herein in its respective entirety for all purposes

In some embodiments, the sorbent polymer composite comprises at least one phosphonium halide. In some embodiments, the at least one phosphonium halide is disposed on the sorbent polymer composite. In some embodiments, the at least one phosphonium halide is disposed within the sorbent polymer composite. In some embodiments, the at least one phosphonium halide is disposed on and within the at least one phosphonium halide. In some embodiments, the at least one phosphonium halide may be located within any porosity of the sorbent polymer composite material. In some embodiments, the at least one phosphonium halide may be incorporated into the sorbent polymer composite by any suitable technique which may include, but is not limited to, imbibing, impregnating, adsorbing, mixing, sprinkling, spraying, dipping, painting, coating, ion exchanging or otherwise applying the at least one phosphonium halide to the sorbent polymer composite.

In some embodiments, the at least one phosphonium halide comprises a compound with a formula: P(R₁R₂R₃R₄)X. In some embodiments, X=I⁻, Br⁻, I₃⁻, BrI₂⁻, Br₂I⁻, or Br₃⁻.

In some embodiments, at least one of R₁, R₂, R₃ or R₄ is hydrogen.

In some embodiments, at least one of R₁, R₂, R₃ or R₄ is a hydrocarbon having from 1 to 18 carbon atoms. In some embodiments, at least one of R₁, R₂, R₃ or R₄ is a hydrocarbon having from 2 to 18 carbon atoms. In some embodiments, at least one of R₁, R₂, R₃ or R₄ is a hydrocarbon having from 3 to 18 carbon atoms. In some embodiments, at least one of R₁, R₂, R₃ or R₄ is a hydrocarbon having from 4 to 18 carbon atoms. In some embodiments, at least one of R₁, R₂, R₃ or R₄ is a hydrocarbon having from 5 to 18 carbon atoms. In some embodiments, at least one of R₁, R₂, R₃ or R₄ is a hydrocarbon having from 6 to 18 carbon atoms. In some embodiments, at least one of R₁, R₂, R₃ or R₄ is a hydrocarbon having from 7 to 18 carbon atoms. In some embodiments, at least one of R₁, R₂, R₃ or R₄ is a hydrocarbon having from 8 to 18 carbon atoms. In some embodiments, at least one of R₁, R₂, R₃ or R₄ is a hydrocarbon having from 9 to 18 carbon atoms. In some embodiments, at least one of R₁, R₂, R₃ or R₄ is a hydrocarbon having from 10 to 18 carbon atoms. In some embodiments, at least one of R₁, R₂, R₃ or R₄ is a hydrocarbon having from 11 to 18 carbon atoms. In some embodiments, at least one of R₁, R₂, R₃ or R₄ is a hydrocarbon having from 12 to 18 carbon atoms. In some embodiments, at least one of R₁, R₂, R₃ or R₄ is a hydrocarbon having from 13 to 18 carbon atoms. In some embodiments, at least one of R₁, R₂, R₃ or R₄ is a hydrocarbon having from 14 to 18 carbon atoms. In some embodiments, at least one of R₁, R₂, R₃ or R₄ is a hydrocarbon having from 15 to 18 carbon atoms. In some embodiments, at least one of R₁, R₂, R₃ or R₄ is a hydrocarbon having from 16 to 18 carbon atoms. In some embodiments, at least one of R₁, R₂, R₃ or R₄ is a hydrocarbon having from 17 to 18 carbon atoms.

In some embodiments, at least one of R₁, R₂, R₃ or R₄ is a hydrocarbon having from 1 to 17 carbon atoms. In some embodiments, at least one of R₁, R₂, R₃ or R₄ is a hydrocarbon having from 1 to 16 carbon atoms. In some embodiments, at least one of R₁, R₂, R₃ or R₄ is a hydrocarbon having from 1 to 15 carbon atoms. In some embodiments, at least one of R₁, R₂, R₃ or R₄ is a hydrocarbon having from 1 to 14 carbon atoms. In some embodiments, at least one of R₁, R₂, R₃ or R₄ is a hydrocarbon having from 1 to 13 carbon atoms. In some embodiments, at least one of R₁, R₂, R₃ or R₄ is a hydrocarbon having from 1 to 12 carbon atoms. In some embodiments, at least one of R₁, R₂, R₃ or R₄ is a hydrocarbon having from 1 to 11 carbon atoms. In some embodiments, at least one of R₁, R₂, R₃ or R₄ is a hydrocarbon having from 1 to 10 carbon atoms. In some embodiments, at least one of R₁, R₂, R₃ or R₄ is a hydrocarbon having from 1 to 9 carbon atoms. In some embodiments, at least one of R₁, R₂, R₃ or R₄ is a hydrocarbon having from 1 to 8 carbon atoms. In some embodiments, at least one of R₁, R₂, R₃ or R₄ is a hydrocarbon having from 1 to 7 carbon atoms. In some embodiments, at least one of R₁, R₂, R₃ or R₄ is a hydrocarbon having from 1 to 6 carbon atoms. In some embodiments, at least one of R₁, R₂, R₃ or R₄ is a hydrocarbon having from 1 to 5 carbon atoms. In some embodiments, at least one of R₁, R₂, R₃ or R₄ is a hydrocarbon having from 1 to 4 carbon atoms. In some embodiments, at least one of R₁, R₂, R₃ or R₄ is a hydrocarbon having from 1 to 3 carbon atoms. In some embodiments, at least one of R₁, R₂, R₃ or R₄ is a hydrocarbon having from 1 to 2 carbon atoms.

In some embodiments, at least one of R₁, R₂, R₃ or R₄ is a hydrocarbon having from 2 to 18 carbon atoms. In some embodiments, at least one of R₁, R₂, R₃ or R₄ is a hydrocarbon having from 3 to 17 carbon atoms. In some embodiments, at least one of R₁, R₂, R₃ or R₄ is a hydrocarbon having from 4 to 16 carbon atoms. In some embodiments, at least one of R₁, R₂, R₃ or R₄ is a hydrocarbon having from 5 to 15 carbon atoms. In some embodiments, at least one of R₁, R₂, R₃ or R₄ is a hydrocarbon having from 6 to 14 carbon atoms. In some embodiments, at least one of R₁, R₂, R₃ or R₄ is a hydrocarbon having from 7 to 13 carbon atoms. In some embodiments, at least one of R₁, R₂, R₃ or R₄ is a hydrocarbon having from 8 to 12 carbon atoms. In some embodiments, at least one of R₁, R₂, R₃ or R₄ is a hydrocarbon having from 9 to 11 carbon atoms.

In some embodiments, the hydrocarbon of the at least one phosphonium halide is chosen from an alkyl, an aryl, or a cyclic alkyl. In some embodiments, the hydrocarbon of the at least one phosphonium halide is selected from the group consisting of an alkyl, an aryl, or a cyclic alkyl.

In some embodiments, the at least one phosphonium halide comprises a quaternary phosphonium iodide, a quaternary phosphonium bromide, a quaternary phosphonium triiodide, or any combination thereof. In some embodiments, the at least one phosphonium halide is selected from the group consisting of a quaternary phosphonium iodide, a quaternary phosphonium bromide, a quaternary phosphonium triiodide, or any combination thereof.

In some embodiments, the at least one phosphonium halide comprises a quaternary phosphonium iodide. In some embodiments, the at least one phosphonium halide comprises a quaternary phosphonium bromide. In some embodiments, the at least one phosphonium halide comprises a quaternary phosphonium triiodide. In some embodiments, the at least one phosphonium halide comprises a quaternary phosphonium tribromide.

In some embodiments, the at least one phosphonium halide comprises tetrabutylphosphonium iodide (TBPI), ethyltriphenylphosphonium triiodide (ETPPI3), tetrabutyl phosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutyl phosphonium iodide (TBPI), ethyltriphenylphosphonium triiodide (ETPPI3), tetrabutyl phosphonium bromide (TBPBr), ethyltriphenylphosphonium bromide (ETPPBr), ethyltriphenylphosphonium iodide (ETPPI), and any combination thereof.

In some embodiments, the at least one phosphonium halide comprises tetrabutyl phosphonium iodide (TBPI), ethyltriphenylphosphonium triiodide (ETPPI3), tetrabutyl phosphonium bromide (TBPBr), ethyltriphenylphosphonium bromide (ETPPBr), or any combination thereof. In some embodiments, the at least one phosphonium halide is selected from the group consisting of tetrabutyl phosphonium iodide (TBPI), ethyltriphenylphosphonium triiodide (ETPPI₃), tetrabutylphosphonium bromide (TBPBr), ethyltriphenylphosphonium bromide (ETPPBr), and any combination thereof.

In some embodiments, the at least one phosphonium halide is ethyltriphenylphosphonium iodide (ETPPI).

In some embodiments, the at least one phosphonium halide is thermally stable, such that the at least one phosphonium halide retains a single molecular formula, at temperatures in excess of 180° C. In some embodiments, the at least one phosphonium halide is thermally stable, such that the at least one phosphonium halide retains a single molecular formula, at temperatures in excess of 200° C. In some embodiments, the at least one phosphonium halide is thermally stable, such that the at least one phosphonium halide retains a single molecular formula, at temperatures in excess of 220° C. In some embodiments, the at least one phosphonium halide is thermally stable, such that the at least one phosphonium halide retains a single molecular formula, at temperatures in excess of 240° C. In some embodiments, the at least one phosphonium halide is thermally stable, such that the at least one phosphonium halide retains a single molecular formula, at temperatures in excess of 260° C. In some embodiments, the at least one phosphonium halide is thermally stable, such that the at least one phosphonium halide retains a single molecular formula, at temperatures in excess of 280° C. In some embodiments, the at least one phosphonium halide is thermally stable, such that the at least one phosphonium halide retains a single molecular formula, at temperatures in excess of 300° C. In some embodiments, the at least one phosphonium halide is thermally stable, such that the at least one phosphonium halide retains a single molecular formula, at temperatures in excess of 320° C. In some embodiments, the at least one phosphonium halide is thermally stable, such that the at least one phosphonium halide retains a single molecular formula, at temperatures in excess of 340° C. In some embodiments, the at least one phosphonium halide is thermally stable, such that the at least one phosphonium halide retains a single molecular formula, at temperatures in excess of 360° C. In some embodiments, the at least one phosphonium halide is thermally stable, such that the at least one phosphonium halide retains a single molecular formula, at temperatures in excess of 380° C. In some embodiments, the at least one phosphonium halide is thermally stable, such that the at least one phosphonium halide retains a single molecular formula, at temperatures in excess of 400° C.

In some embodiments, the at least one phosphonium halide is thermally stable, such that the at least one phosphonium halide retains a single molecular formula, at temperatures from 180° C. to 400° C. In some embodiments, the at least one phosphonium halide is thermally stable, such that the at least one phosphonium halide retains a single molecular formula, at temperatures from 200° C. to 400° C. In some embodiments, the at least one phosphonium halide is thermally stable, such that the at least one phosphonium halide retains a single molecular formula, at temperatures from 220° C. to 400° C. In some embodiments, the at least one phosphonium halide is thermally stable, such that the at least one phosphonium halide retains a single molecular formula, at temperatures from 240° C. to 400° C. In some embodiments, the at least one phosphonium halide is thermally stable, such that the at least one phosphonium halide retains a single molecular formula, at temperatures from 260° C. to 400° C. In some embodiments, the at least one phosphonium halide is thermally stable, such that the at least one phosphonium halide retains a single molecular formula, at temperatures from 280° C. to 400° C. In some embodiments, the at least one phosphonium halide is thermally stable, such that the at least one phosphonium halide retains a single molecular formula, at temperatures from 300° C. to 400° C. In some embodiments, the at least one phosphonium halide is thermally stable, such that the at least one phosphonium halide retains a single molecular formula, at temperatures from 320° C. to 400° C. In some embodiments, the at least one phosphonium halide is thermally stable, such that the at least one phosphonium halide retains a single molecular formula, at temperatures from 340° C. to 400° C. In some embodiments, the at least one phosphonium halide is thermally stable, such that the at least one phosphonium halide retains a single molecular formula, at temperatures from 360° C. to 400° C. In some embodiments, the at least one phosphonium halide is thermally stable, such that the at least one phosphonium halide retains a single molecular formula, at temperatures from 380° C. to 400° C.

In some embodiments, the at least one phosphonium halide is thermally stable, such that the at least one phosphonium halide retains a single molecular formula, at temperatures from 180° C. to 380° C. In some embodiments, the at least one phosphonium halide is thermally stable, such that the at least one phosphonium halide retains a single molecular formula, at temperatures from 180° C. to 360° C. In some embodiments, the at least one phosphonium halide is thermally stable, such that the at least one phosphonium halide retains a single molecular formula, at temperatures from 180° C. to 340° C. In some embodiments, the at least one phosphonium halide is thermally stable, such that the at least one phosphonium halide retains a single molecular formula, at temperatures from 180° C. to 320° C. In some embodiments, the at least one phosphonium halide is thermally stable, such that the at least one phosphonium halide retains a single molecular formula, at temperatures from 180° C. to 300° C. In some embodiments, the at least one phosphonium halide is thermally stable, such that the at least one phosphonium halide retains a single molecular formula, at temperatures from 180° C. to 280° C. In some embodiments, the at least one phosphonium halide is thermally stable, such that the at least one phosphonium halide retains a single molecular formula, at temperatures from 180° C. to 260° C. In some embodiments, the at least one phosphonium halide is thermally stable, such that the at least one phosphonium halide retains a single molecular formula, at temperatures from 180° C. to 240° C. In some embodiments, the at least one phosphonium halide is thermally stable, such that the at least one phosphonium halide retains a single molecular formula, at temperatures from 180° C. to 220° C. In some embodiments, the at least one phosphonium halide is thermally stable, such that the at least one phosphonium halide retains a single molecular formula, at temperatures from 180° C. to 200° C.

In some embodiments, the at least one phosphonium halide is thermally stable, such that the at least one phosphonium halide retains a single molecular formula, at temperatures from 200° C. to 380° C. In some embodiments, the at least one phosphonium halide is thermally stable, such that the at least one phosphonium halide retains a single molecular formula, at temperatures from 220° C. to 360° C. In some embodiments, the at least one phosphonium halide is thermally stable, such that the at least one phosphonium halide retains a single molecular formula, at temperatures from 240° C. to 340° C. In some embodiments, the at least one phosphonium halide is thermally stable, such that the at least one phosphonium halide retains a single molecular formula, at temperatures from 260° C. to 320° C. In some embodiments, the at least one phosphonium halide is thermally stable, such that the at least one phosphonium halide retains a single molecular formula, at temperatures from 280° C. to 300° C.

Some embodiments of the present disclosure relate to a method. In some embodiments, the method comprises treating a flue gas stream, such as, but not limited to, any flue gas stream described herein. In some embodiments, the method comprises obtaining a flue gas stream from a combustion process. In some embodiments, the method comprises obtaining the flue gas stream directly from a combustion process, such that the flue gas stream consists entirely of combustion byproducts. In some embodiments, the method comprises obtaining the flue gas stream indirectly from a combustion process, whereby the flue gas stream is subjected to at least one intermediate step (e.g., scrubbing), before any other treatment steps described herein are performed.

In some non-limiting embodiments, the flue gas stream to be treated is obtained by adding water vapor and oxygen to an initial flue gas stream that includes at least one Sax compound described herein. However, in some embodiments, the water vapor and oxygen are not added to an initial flue gas stream, but are instead present as byproducts of the combustion process. In some non-limiting embodiments, the flue gas stream to be treated is obtained by adding water vapor and oxygen to an initial flue gas stream that includes mercury vapor. In some non-limiting embodiments, the flue gas stream to be treated is obtained by adding water vapor and oxygen to an initial flue gas stream that includes a mixture of at least one SOₓ compound described herein and mercury vapor. In some non-limiting embodiments, the flue gas stream to be treated is obtained by: first adding water vapor and oxygen to a first initial flue gas stream that includes at least one SOₓ compound to form a mixture; and then adding a second initial flue gas stream that includes mercury vapor to the mixture. In some non-limiting embodiments, the flue gas stream to be treated is obtained by: first adding water vapor and oxygen to a first initial flue gas stream comprising mercury vapor to form a mixture; and then adding a second initial flue gas stream comprising at least one SOₓ compound to the mixture. In some embodiments, any flue gas stream to be treated, any initial flue gas stream described herein, or any combination thereof, may be an exhaust stream from a combustion process.

In some embodiments, the method of treating the flue gas stream further comprises passing the flue gas stream over a device, such as, but not limited to, any device described herein. In some embodiments, the method of treating the flue gas stream further comprises reacting oxygen and water vapor from the flue gas stream with the at least one SOₓ compound of the flue gas stream on a sorbent polymer composite (e.g., any sorbent polymer composite described herein) so as to form sulfuric acid. In some embodiments, the method of treating the flue gas stream further comprises reacting mercury vapor from the with at least one phosphonium halide (e.g., any phosphonium ion described herein), so as to fix molecules of the mercury vapor to the sorbent polymer composite.

### EXAMPLES

The following Examples illustrate certain embodiments of the present disclosure and are not intended to be limiting.

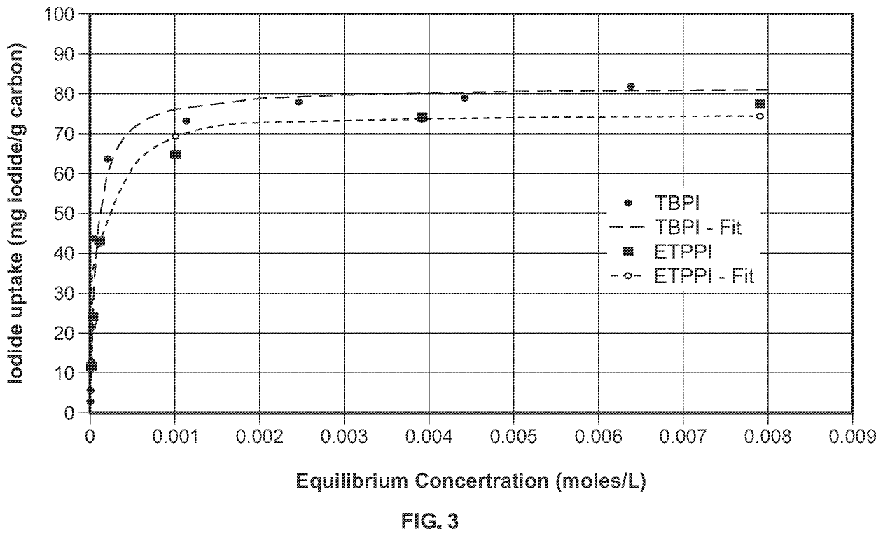

FIG. 3 is a chart showing the Langmuir adsorption isotherms of various exemplary phosphonium halides in accordance with some embodiments of the present disclosure. Specifically, FIG. 3 depicts exemplary adsorptions of TBPI and ETPPI on an activated carbon sorbent. The adsorption of TBPI and ETPPI from solution may, in some embodiments, be characterized by an associated K value, which may provide an indication of the adsorption capacity. Put differently, higher K values can indicate an affinity of a given phosphonium halide on a given sorbent. As shown in the Example of FIG. 3, for ETPPI, the value of K was ˜34,000 mg iodine/g carbon/(moles/L).

A K value may be derived by from fitting the data of FIG. 3 or an analogous plot to a Langmuir adsorption isotherm. Specifically, the Langmuir adsorption isotherm, θ=(KC_{eq}/(1+KC_{eq}). The Langmuir adsorption isotherm, θ can be characterized as the dimensionless fractional surface coverage. The Langmuir adsorption isotherm, θ may be defined as measured uptake (in g/g of adsorbent) divided by the maximum uptake capacity (in g/g of adsorbent). The maximum uptake capacity may be derived from fitting the data. K may be viewed as an adsorption equilibrium constant. For example, for ETTPI on a carbon sorbent, an equilibrium reaction may be as follows: ETPPI(aq)+Carbon↔ETPPI(ads), where “aq” designates an amount of ETTPI in an aqueous phase and “ads” indicates an amount of ETTPI adsorbed on the carbon sorbent. Of course, similar equilibrium reactions may exist for other types of sorbents and phosphonium salts described herein.

Generally, speaking the larger the value of K the further the equilibrium lies to the right (i.e., toward the adsorption phase), and consequently the adsorbed species (e.g., the at least one phosphonium halide) is more durable to leaching.

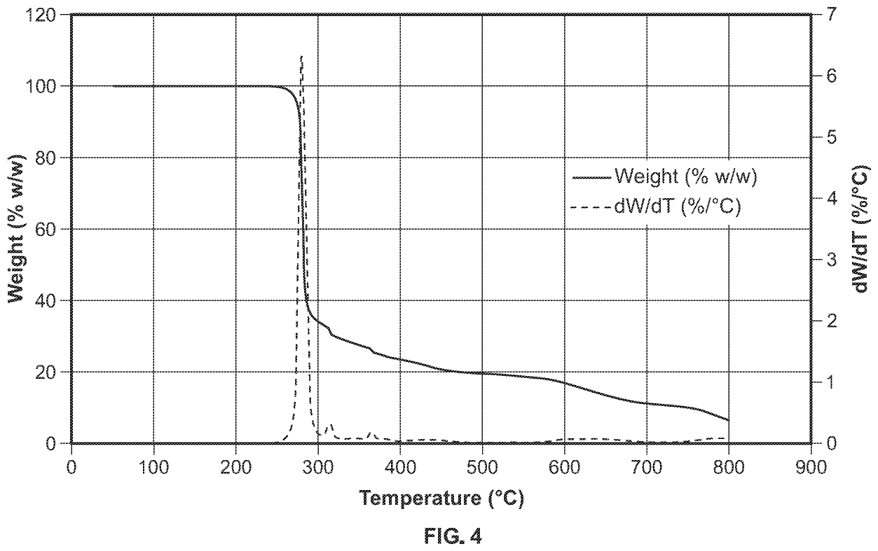

FIGS. 4-8 show a thermal gravimetric analysis (TGA) that demonstrates the temperatures at which some phosphonium halides decompose. A thermal gravimetric analysis was performed by elevating the sample temperature slowly from ambient to 800° C. while measuring mass loss under an air atmosphere using TA Instruments Hi-Res Dynamic Method, respectively, using a TGA V5000 thermogravimetric analyzer made by TA Instruments. In the production of sorbent polymer composites, and in subsequent processing steps, it is not uncommon for the sorbent polymer composites to be subjected to temperatures in excess of 180° C. for certain periods of time. Occasionally, process upsets can lead to longer exposure at elevated temperature, Similarly, in application, process upsets can result in the exposure of the sorbent polymer composite to elevated flue gas stream temperatures. Phosphonium salts with peak decomposition temperature in excess of 200° C. may, in some embodiments, be suitable for applications where these temperatures are reached.

In each of the FIGS. 4-8, the solid line indicates the change in mass. The dotted line is the first derivative. The peak in the derivative indicates a maximum rate of decomposition and can be taken as an indicator of the relative thermal stability of the phosphonium halides.

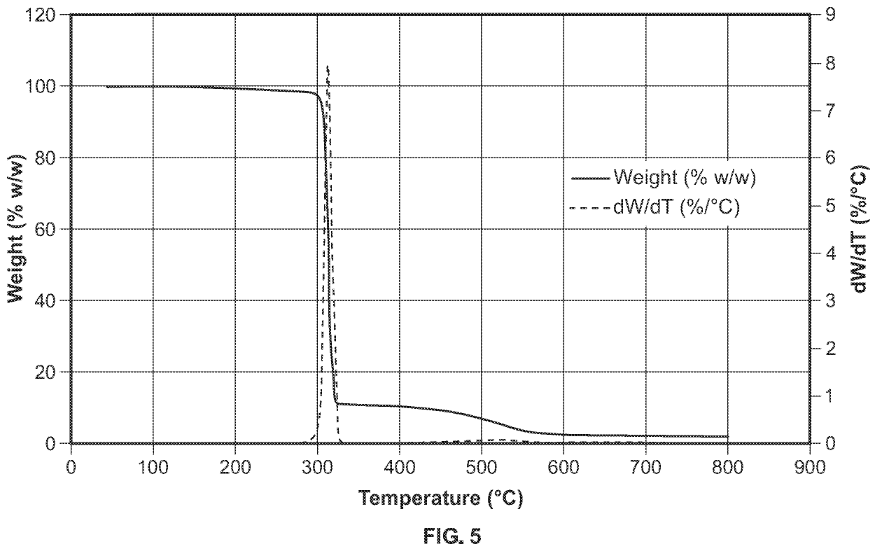

FIGS. 4 and 5 are TGA data for ETPPI (402) and TBPI (403), respectively, which have peak decomposition temperatures of 280° C. and 313° C., respectively. Accordingly, in some embodiments, and for certain phosphonium halides, a sorbent polymer composite incorporating the phosphonium can tolerate processing without significant degradation at temperatures in excess of 200° C.

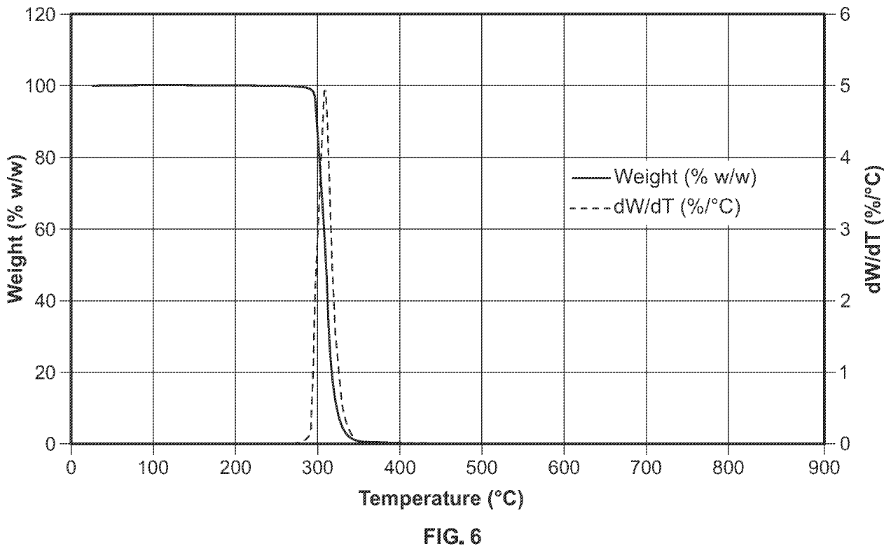

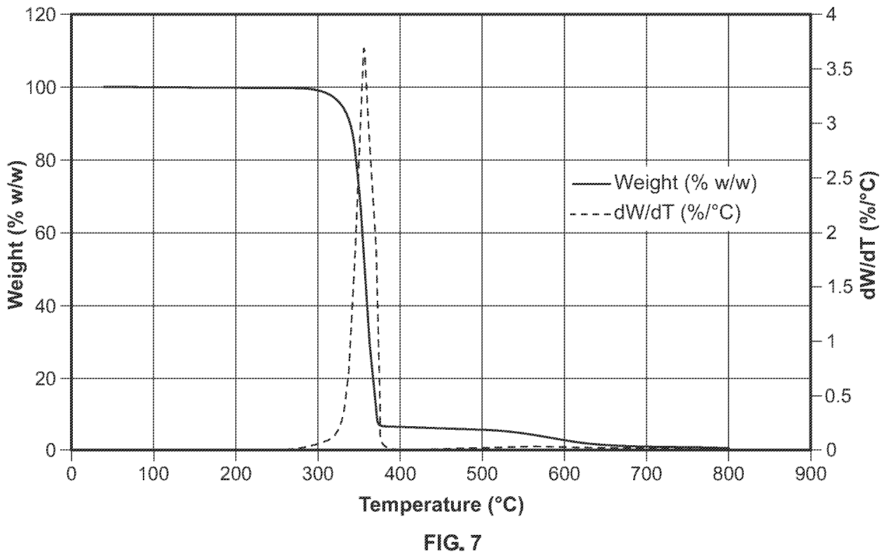

FIGS. 6 and 7 are the TGA data on ETPPBr and TBPBr respectively. The peak decomposition temperatures of these compounds were 304° C. and 355° C., respectively, which extends a usable range to in excess of 300° C. ETPPBr has a maximum desorption peak at 304° C. and TBPBr had a maximum desorption peak at 355° C.

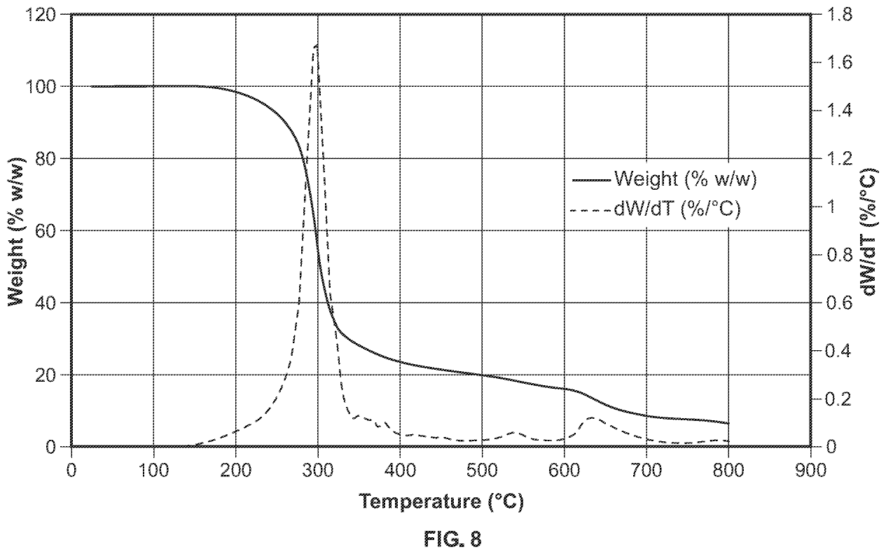

FIG. 8 also shows the TGA of ETPPI₃. The maximum rate of decomposition of ETPPI₃ occurred at 297° C. for ETPPI₃ (i.e., 297° C.) is similar to the temperature of decomposition of ETPPI, but has initial decomposition began well below 200° C. making ETPPI more suitable for applications up to 150° C. in some embodiments.

Incorporation of quaternary phosphonium iodides into sorbent polymer composites can be accomplished by any number of methods that are known to those skilled in the art. It may be included as a component during the initial formulation, or may be imbibed into the preformed composite from solution or the melt. For the purposes of demonstration, TPBI and ETTPI were absorbed into the sorbent polymer composite from a methanol solution. In some embodiments, the sorbent may be impregnated with iodide salt, before, during or after processing into a sorbent polymer composite.

Exemplary Tests for Mercury Vapor Removal

Exemplary Tests for mercury vapor removal were performed using an apparatus including (1) a supply of air regulated by a mass flow controller (2) a mercury source produced by means a small nitrogen purge through of a DYNACALIBRATOR Calibration Gas Generators (VICI Metronics, Inc., Poulsbo, Wash., USA), comprising a mercury permeation tube (3) a sample cell fitted with a bypass, and located in an oven maintained at 65° C. and (4) a stannous chloride/H₂SO₄ bubbler to convert any oxidized mercury to elemental mercury and (5) mercury detection by means of an RA915+ Mercury Analyzer (OHIO LUMEX Co., Inc., Ohio, USA), equipped with a short path length gas cell.

Mercury remediation efficiency (η) is reported as the difference between inlet mercury levels (bypassing the sample) and outlet levels (passing through the sample) divided by the inlet concentration.

η=(Inlet concentration−outlet concentration)/(inlet concentration)

### PHOSPHONIUM IODIDE EXAMPLES

### Phosphonium Iodide Example 1: Adsorption of Mercury Vapor by an ETPPI Imbibed 55/45 Carbon/PTFE Sorbent Polymer Composite

A sorbent polymer composite comprising 55 parts activated carbon (Westvaco NUCHAR SA20) and 45 parts PTFE was prepared as described in U.S. Pat. No. 7,442,352. This material was cut into a 10 mm×150 mm strip, weighing 0.63 g. The strip was contacted with 10 ml of a solution comprising 0.1 grams of ETPPI (Deepwater Chemicals Inc., Okla., USA) dissolved in methanol (Sigma Aldrich Inc., Mich., USA) overnight. This treated strip or tape was removed and air dried, and then tested for mercury removal efficiency in a 1 cm by 1 cm square glass container. Total flow rate was 10 slpm (standard liters per minute), and the mercury concentration was 120 pg/m³. Removal efficiency was determined by comparison of the inlet and outlet mercury concentrations, as measured by an RA915+ Mercury Analyzer using a short path-length cell. Separate efficiencies were measured using dry air and air humidified to 80-90% relative humidity, resulting in efficiencies of 27.3% and 26.3%, respectively, in dry and wet air streams.

### Phosphonium Iodide Comparative Example 1: Adsorption of Mercury by an Untreated 55/45 Carbon/PTFE Sorbent Polymer Composite

A sample of the untreated sorbent polymer composite strip from Phosphonium Iodide Example 1 was also tested for efficiency without an added phosphonium halide, using the same conditions described in Example 1. The measured efficiencies were 9.5% and 1.6% in dry and wet air streams, respectively. A comparison between the efficiencies of the treated and untreated carbon/polymer indicates that, while some portion of the mercury appears to be adsorbed by the suspended carbon alone, the inclusion of the phosphonium iodide increases the adsorption rate, particularly in a humid air stream.

### Phosphonium Iodide Example 2: Adsorption of Mercury by an ETPPI Imbibed 80/20 Carbon/PTFE Sorbent Polymer Composite

A sorbent polymer composite comprising 80 parts activated carbon (NORIT-CABOT PAC20BF) and 20 parts of PTFE was prepared using the general dry blending methodology taught in U.S. Pat. No. 7,791,861 B2 to Mitchell et al. to form composite tapes that were then uniaxially expanded according to the teachings of U.S. Pat. No. 3,953,566 to Gore. This material was cut into a 10 mm×150 mm strip, weighing 0.87 g. The strip was contacted with 10 ml of a solution comprising 0.1 grams of ETPPI dissolved in methanol (Sigma Aldrich Inc., Mich., USA) overnight as described above with respect to Iodide Example 1, and then removed from the solution and air dried. This material was tested for mercury removal efficiency in a 1 cm by 1 cm square glass container under the same conditions as for Phosphonium Iodide Example 1, i.e., a total flow rate of 10 slpm and mercury concentration of 120 μg/m³. Removal efficiency was also determined by the same methods as per Phosphonium Iodide Example 1, using an RA915+ Mercury Analyzer using a short path-length cell, resulting in measured efficiencies of 31.6% and 29.2% in dry and humid air, respectively.

### Phosphonium Iodide Comparative Example 2: Adsorption of Mercury by an Untreated 80/20 Carbon/PTFE Sorbent Polymer Composite

A sample of an untreated sorbent polymer composite sheet from Phosphonium Iodide Example 2 was also tested for efficiency using the same conditions described in Phosphonium Iodide Example 2. The measured efficiencies were 24.1% and 12.7% in dry and 80-90% humid air streams, respectively. As with Phosphonium Iodide Example 1, a comparison between the treated and untreated sorbent polymer composites shows that, in some embodiments, inclusion of the phosphonium halide dramatically improves mercury capture, particularly in a humid air stream.

### Phosphonium Iodide Example 3: Adsorption of Mercury by a TBPI Imbibed 55/45 Carbon/PTFE Sorbent Polymer Composite

A sorbent polymer composite comprising 55 parts activated carbon (Westvaco NUCHAR SA20) and 45 parts PTFE was prepared as described in U.S. Pat. No. 7,442,352. The material was cut into a 10 mm×150 mm strip (0.61 g). A TBPI solution was prepared comprising 0.5 g TBPI (Alfa Aesar, Inc., Mass., USA) dissolved in 100 ml of deionized (DI) water. The sorbent polymer composite strip was contacted with 10 ml of TBPI solution and 10 ml of DI water overnight, and subsequently removed from solution and over dried at 120° C. for 1 hour. This material was tested for mercury removal efficiency in a 1 cm by 1 cm square glass container according to the same methods described with respect to the previous examples, with a total flow rate of 10 slpm, and a mercury concentration of 120 μg/m³. Removal efficiency was also determined by the same methods as per Example 1, resulting in measured efficiencies of 32.8% and 31.8%, respectively, in dry and 80-90% humid air.

### Phosphonium Iodide Example 4: Adsorption of Mercury by a TBPI Imbibed 80/20 Carbon/PTFE Sorbent Polymer Composite

A sorbent polymer composite comprising 80 parts activated carbon (NORIT-CABOT PAC20BF) and 20 parts of PTFE was prepared using the general dry blending methodology taught in U.S. Pat. No. 7,791,861 to Mitchell et al. to form composite tapes that were then uniaxially expanded according to the teachings of U.S. Pat. No. 3,953,566 to Gore. This material was cut into a 10 mm×150 mm strip, weighing 0.85 g. A TBPI solution was prepared comprising 0.5 g TBPI dissolved in 100 ml of DI water. The sorbent polymer composite strip was contacted with 10 ml of the TBPI solution and 10 ml of DI water overnight, and then subsequently removed and dried in an oven at 120° C. for 1 hour. This material was tested for mercury removal efficiency in a 1 cm by 1 cm square glass container under the same conditions as for the preceding examples, at a total flow rate of 10 slpm, and with a mercury concentration was 120 μg/m³. Removal efficiency was also determined by the same methods as per Phosphonium Iodide Example 1, resulting in measured efficiencies of 26.1 and 23.6%, respectively, in dry and 80-90% humid air.

As noted above, the treated composites formed using both ETPPI and TBPI achieve mercury removal efficiencies on the order of about 26-32% (ETPPI) and about 24-33% (TBPI), all of which demonstrate improved mercury capture of the treated composites over composites using carbon alone.

Preparation of Ethyltriphenylphosphonium Triiodide (ETPPI₃)

ETPPI₃ was prepared by reacting ETPPI in solution with an iodine solution, as follows. An ETPPI solution was prepared by dissolving 1 g of ETPPI in 100 ml of isopropanol (IPA). 30 ml of this solution (nominally 0.72 mmoles) was reacted with 15 ml of 0.1 N iodine solution (1.5 meq). After 15 minutes, 100 ml of DI water was added to help solubilize excess KI from the iodine solution and to reduce the solubility of the tri-iodide salt. The product was filtered, and dried in a vacuum desiccator overnight. 0.4657 grams of bronze-brown crystalline product was recovered.

The reaction is as follows: EtPh₃PI+I₂→EtPh₃PI₃

The product of the reaction was submitted to Galbraith Laboratories in Knoxville, Tenn. for microanalysis. The theoretical composition for ETPPI₃ is: C=35.7%, H=3.0%, P=4.6%, I=56.6%; and the analysis found a composition of: C=36.4%, H=2.94% P=4.63%, and I=56.96%. The microanalysis of the product is thus in good agreement with the theoretical composition.

### Phosphonium Iodide Example 5: Adsorption of Mercury by an ETPPI₃ Imbibed 80/20 Carbon/PTFE Sorbent Polymer Composite

A sorbent polymer composite comprising 80 parts activated carbon (NORIT-CABOT PAC20BF) and 20 parts of PTFE was prepared using the general dry blending methodology taught in U.S. Pat. No. 7,791,861 to Mitchell et al. to form composite tapes that were then uniaxially expanded according to the teachings of U.S. Pat. No. 3,953,566 to Gore. This material was cut into a 10 mm×150 mm strip, weighing 0.8 g. The strip was then contacted with a solution comprising 0.0211 g of ETPPI₃, which was prepared as described above, and dissolved in 3 ml methylene chloride, for a contact period of 15 minutes, and then dried in an oven at 120° C. for 1 hour. The treated composite was tested for mercury removal efficiency in a 1 cm by 1 cm square glass container according to the test methods as described in the preceding examples, with a total flow rate of 10 slpm, at a mercury concentration of 120 μg/m³. Removal efficiency was also determined by the same methods as per the preceding examples, resulting in measured efficiencies of 26.5 and 24.6%, respectively, in dry and 80-90% humid air.

### PHOSPHONIUM BROMIDE EXAMPLES

### Phosphonium Bromide Example 1: Adsorption of Mercury by an ETPPBr Imbibed 60/40 Carbon/PTFE Sorbent Polymer Composite

A sorbent polymer composite comprising 60 parts activated carbon (Westvaco NUCHAR SA20) and 40 parts PTFE was prepared as described in U.S. Pat. No. 7,442,352. This material was cut into a 10 mm×150 mm strip, weighing 0.67 g. The strip was then contacted with a solution comprising 0.1 grams of ETPPBr dissolved in 10 ml methanol (both from Sigma Aldrich Inc., Mich., USA) for about 1 hour. The treated tape was removed from the solution and air dried, and then tested for mercury removal efficiency in a 1 cm by 1 cm square glass container under a total flow rate of 10 slpm with a mercury concentration of 120 μg/m³. Removal efficiency was determined by comparison of the inlet and outlet mercury concentrations, as measured by an RA915+ Mercury Analyzer using a short path-length cell. Separate efficiencies were measured using dry air and air humidified to 80-90% relative humidity, resulting in measured efficiencies of 28.6% and 20.0% respectively, in dry and humid air.

### Phosphonium Bromide Comparative Example 1: Adsorption of Mercury by an Untreated 60/40 Carbon/PTFE Sorbent Polymer Composite

A sample of untreated sorbent polymer composite sheet from Bromide Example 1, above, was also tested for efficiency using the same conditions described in Example 1. The measured efficiencies were 0.2% and 1.1% in dry and wet air streams respectively. A comparison between the efficiencies of the imbibed and untreated carbon/polymer indicates that, while some portion of the mercury appears to be adsorbed by the suspended carbon alone, the inclusion of the phosphonium bromide increases the adsorption rate, particularly in a humid air stream, and with similar performance to the phosphonium iodide examples described above.

### Phosphonium Bromide Example 2: Adsorption of Mercury by an ETPPBr Imbibed 70/30 Carbon/PTFE Sorbent Polymer Composite

A sorbent polymer composite comprising 70 parts activated carbon (NORIT-CABOT PAC20BF) and 30 parts PTFE was prepared as described in U.S. Pat. No. 7,442,352. This material was cut into a 10 mm×150 mm strip, weighing 1.1 g. The treated strip was contacted with a 10 ml solution comprising 0.1 grams of ETPPBr dissolved in 10 ml methanol (Sigma Aldrich Inc., Mich., USA) for about an hour. The tape was removed from solution, air dried, and then tested for mercury removal efficiency in a 1 cm by 1 cm square glass container with a total flow rate of 10 slpm, and a mercury concentration of 120 μg/m³. Removal efficiency was determined by comparison of the inlet and outlet mercury concentrations, as measured an RA915+ Mercury Analyzer using a short path-length cell. Efficiency was measured using dry air and air humidified to 80-90% relative humidity, resulting in measured efficiencies of 31.9% and 24.9% respectively, in dry and humid air.

### Phosphonium Bromide Comparative Example 2: Adsorption of Mercury by an Untreated 70/30 Carbon/PTFE Sorbent Polymer Composite

A sample of untreated sorbent polymer composite sheet from phosphonium bromide Example 2 was also tested for efficiency using the same conditions described above. The measured efficiencies were 19.6% and 5.7% in dry and wet air streams respectively, also indicating that the inclusion of the phosphonium bromide increases the adsorption rate, particularly in a humid air stream.

### Bromide Example 3: Adsorption of Mercury by a TBPBr Imbibed 60/40 Carbon/ PTFE Sorbent Polymer Composite

A sorbent polymer composite comprising 60 parts activated carbon (Westvaco NUCHAR SA20) and 40 parts PTFE was prepared as described in U.S. Pat. No. 7,442,352. This material was cut into a 10 mm×150 mm strip (0.66 g). A solution was prepared comprising 0.1 g TBPBr dissolved in 10 ml of methanol (both from Sigma Aldrich Inc., Mich., USA). The sorbent polymer composite strip was contacted with 10 ml of the TBPBr solution for about an hour, then removed from solution and dried in an oven at 120° C. for 1 hour. The treated material was tested for mercury removal efficiency in a 1 cm by 1 cm square glass container at a total flow rate of 10 slpm, and a mercury concentration of 120 μg/m³. Removal efficiency was determined by comparison of the inlet and outlet mercury concentrations, as measured by an RA915+ Mercury Analyzer using a short path-length cell. Separate efficiencies were measured using dry air and air humidified to 80-90% relative humidity, resulting in measured efficiencies of 28.0% and 20.3% respectively, in dry and humid air.

### Phosphonium Bromide Example 4: Adsorption of Mercury by a TBPBr Imbibed 70/30 Carbon/PTFE Sorbent Polymer Composite

A sorbent polymer composite comprising 70 parts activated carbon (NORIT-CABOT PAC20BF) and 30 parts PTFE was prepared as described in U.S. Pat. No. 7,442,352. This material was cut into a 10 mm×150 mm strip, weighing 1.1 g. A solution was prepared comprising 0.1 g TBPBr dissolved in 10 ml of methanol (both from Sigma Aldrich Inc., Mich., USA). The sorbent polymer composite strip was contacted with 10 ml of the TBPBr solution for about an hour, then removed from solution and dried in an oven at 120° C. for 1 hour. This material was tested for mercury removal efficiency in a 1 cm by 1 cm square glass container. Total flow rate was 10 slpm, and the mercury concentration was 120 μg/m³. Removal efficiency was determined by comparison of the inlet and outlet mercury concentrations, as measured by an RA915+ Mercury Analyzer using a short path-length cell. Efficiency was measured using dry air and air humidified to 80-90% relative humidity, resulting in measured efficiencies of 28.8 and 22.7% respectively, in dry and humid air.

Mercury removal efficiencies as described above with respect to the phosphonium iodide Examples 1-6 and phosphonium bromide Examples 1-4 are summarized for reference in Table 1, below.

TABLE 1
Adsorption of Mercury by Phosphonium Halide Imbibed
Sorbent Polymer Composites

| | | | | | |
|---|---|---|---|---|---|
| | | | | Comp. | Comp. |
| Carbon/ | Phosphonium | Dry | Wet | Dry η | Wet η |
| PTFE | Iodide | η % | η % | % | % |

Phosphonium Iodide Examples

| | | | | | | |
|---|---|---|---|---|---|---|
| Ex. 1 | 55/45 | ETPPI | 27.3 | 26.3 | 9.5 | 1.6 |
| Ex. 2 | 80/20 | ETPPI | 31.6 | 29.3 | 24.2 | 12.7 |
| Ex. 3 | 55/45 | TBPI | 32.8 | 31.8 | 9.5 | 1.6 |
| Ex. 4 | 80/20 | TBPI | 26.1 | 23.6 | 24.2 | 12.7 |
| Ex. 5 | 80/20 | ETPPI₃ | 26.5 | 24.6 | 24.2 | 12.7 |

Phosphonium Bromide Examples

| | | | | | | |
|---|---|---|---|---|---|---|
| Ex. 1 | 60/40 | ETPPBr | 28.6 | 20 | 0.2 | 1.1 |
| Ex. 2 | 70/30 | ETPPBr | 31.9 | 24.9 | 19.6 | 5.7 |
| Ex. 3 | 60/40 | TBPBr | 28 | 20.3 | 0.2 | 1.1 |
| Ex. 4 | 70/30 | TBPBr | 28.8 | 22.7 | 19.6 | 5.7 |

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A device comprising:
a sorbent polymer composite;
wherein the sorbent polymer composite comprises:
a sorbent; and
a polymer; and
at least one phosphonium halide,
wherein the at least one phosphonium halide is:
disposed on the sorbent polymer composite,
disposed within the sorbent polymer composite, or
any combination thereof; and
wherein the device is configured to treat a flue gas stream.

2. The device of claim 1, wherein the at least one phosphonium halide comprises a compound with a formula: P(R₁R₂R₃R₄)X, wherein X=I⁻, Br⁻, I₃⁻, BrI₂⁻, Br₂I⁻, or Br₃⁻, and wherein at least one of R₁, R₂, R₃ or R₄ is a hydrocarbon having from 1 to 18 carbon atoms.

3. The device of claim 2, wherein the hydrocarbon is chosen from an alkyl, an aryl, or a cyclic alkyl.

4. The device of claim 1, wherein the at least one phosphonium halide comprises a quaternary phosphonium iodide.

5. The device of claim 1, wherein the at least one phosphonium halide comprises a quaternary phosphonium bromide.

6. The device of claim 1, wherein the at least one phosphonium halide comprises a quaternary phosphonium triiodide.

7. The device of claim 1, wherein the at least one phosphonium halide comprises a quaternary phosphonium tribromide.

8. The device of claim 1, wherein the at least one phosphonium halide comprises ethyltriphenylphosphonium iodide (ETPPI).

9. The device of claim 1, wherein the at least one phosphonium halide comprises tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), or any combination thereof.

10. The device of claim 1, wherein the at least one phosphonium halide is thermally stable, such that the at least one phosphonium halide retains a single molecular formula, at temperatures in excess of 180° C.

11. The device of claim 10, wherein the at least one phosphonium halide is thermally stable, such that the at least one phosphonium halide retains a single molecular formula, at temperatures from 180° C. to 400° C.

12. The device of claim 11, wherein the at least one phosphonium halide is thermally stable, such that the at least one phosphonium halide retains a single molecular formula, at temperatures from 200° C. to 400° C.

13. (canceled)

14. The device of claim 13, wherein the sorbent of the sorbent polymer composite has a surface area ranging from 400 m²/g to 2000 m²/g.

15. The device of claim 1, wherein the sorbent of the sorbent polymer composite is chosen from: activated carbon, silica gel, zeolites, or any combination thereof.

16. (canceled)

17. The device of claim 16, wherein the polymer of the sorbent polymer composite has a surface energy ranging from 15 dynes per cm to 31 dynes per cm.

18. The device of claim 1, wherein the polymer of the sorbent polymer composite comprises a fluoropolymer.

19. The device of claim 20, wherein the fluoropolymer is expanded polytetrafluoroethylene (ePTFE).

20. A method comprising:
treating a flue gas stream,
wherein the flue gas stream comprises:
oxygen,
water vapor,
at least one SOₓ compound, and
mercury vapor;
wherein treating the flue gas stream comprises:
passing the flue gas stream over a device,
wherein the device comprises:
a sorbent polymer composite;
wherein the sorbent polymer composite
comprises:
a sorbent; and
a polymer; and
at least one phosphonium halide,
wherein the at least one phosphonium halide is: disposed on the sorbent polymer composite, disposed within the sorbent polymer composite, or any combination thereof;
reacting the oxygen and water vapor with the at least one SOₓ compound on the sorbent polymer composite, so as to form sulfuric acid; and
reacting the mercury vapor with the at least one phosphonium halide, so as to fix molecules of the mercury vapor to the sorbent polymer composite.

21. The method of claim 20, further comprising, prior to the treating step, obtaining the flue gas stream from at least one combustion process.

22. The method of claim 20, wherein the at least one SOₓ compound comprises sulfur dioxide (SO₂), sulfur trioxide (SO₃), or any combination thereof.
